(19) United States
(12) Patent Application Publication
(10) Pub. No.: US 2007/0029987 A1
(43) Pub. Date: Feb. 8, 2007

(54) Power factor correction circuit

(76) Inventor: Jian Li, East Sussex (GB)

Correspondence Address: THE BOC GROUP, INC., 575 MOUNTAIN AVENUE, MURRAY HILL, NJ, 07974-2064, US

(21) Appl. No.: 10/572,021

(22) PCT Filed: Aug. 10, 2004
(86) PCT No.: PCT/GB04/03430

§ 371 Date: Mar. 13, 2006

(30) Foreign Application Priority Data
Sep. 11, 2003 (GB) 0321321.2

(51) Int. Cl. H01F 17/00

(52) U.S. Cl. 323/363

(57) ABSTRACT

A power factor correction circuit comprises first and second ac inputs (I1), (I2) for receiving an ac voltage. A rectifier (104) has first and second rectifier inputs (I3), (I4) each connected to a respective ac input (I1), (I2), and first and second rectifier outputs (05), (06) for outputting a dc voltage. Two capacitor banks (C1), (C2) are connected in series between the rectifier outputs (05), (06). A choke (L1) is connected between ac input (I1) and rectifier input (I3). A bi-directional switch (106) is connected to the rectifier inputs (I3), (I4) and receives a control signal for controlling the switching of the bi-directional switch (106) so as to control the charging and discharging of the choke (L1) through the rectifier (104). A mid-point between the capacitor banks (C1), (C2) is selectively connectable, or connected, to the ac input (I2) according to the magnitude of the ac voltage.

The invention relates to a power factor correction circuit.

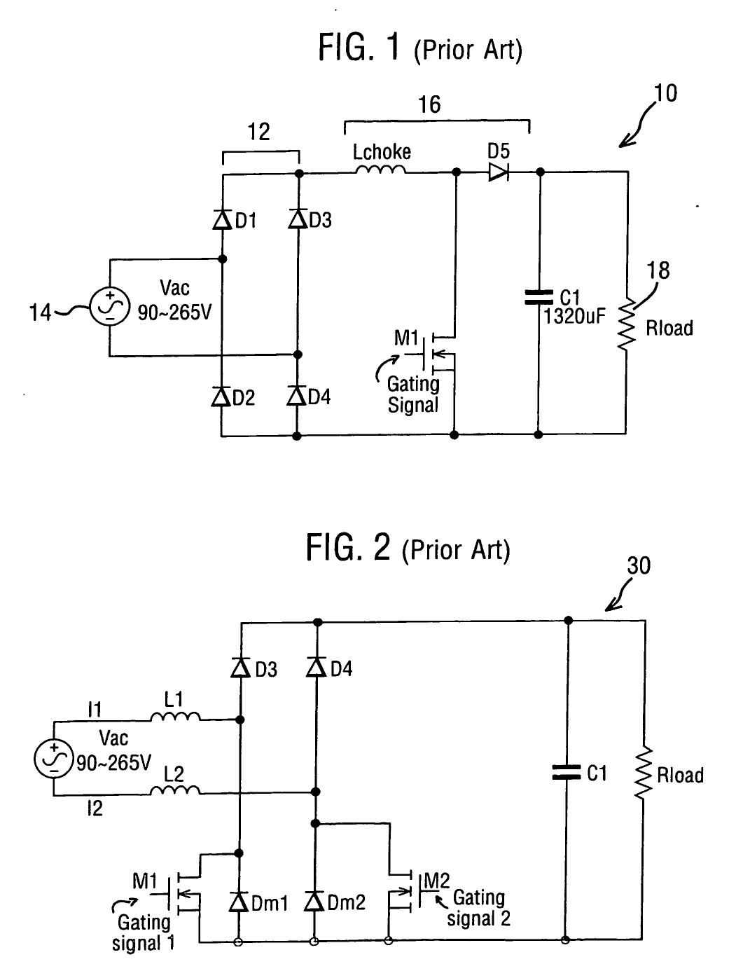

Universal voltage power factor performance is required in the design of many new products. A known power factor correction (PFC) circuit is described in U.S. Pat. No. 4,677,366. With reference to FIG. 1, this power factor correction (PFC) circuit 10 includes a bridge rectifier 12, consisting of diodes D1, D2, D3 and D4, which converts a mains ac voltage received from ac source 14 into a positive sinusoidal voltage. This voltage is fed by the rectifier 12 to a dc booster converter 16 consisting of choke L1, semiconductor switch or MOSFET M1, and a faster reverse recovery diode D5. In operation, a varying gating signal is applied to switch M1. When switch M1 is switched on by the gating signal, a current pulse flows through choke L1 and switch M1, thereby charging choke L1. When switch M1 is switched off by the gating signal, the current pulse continues to flow through choke L1 for a period of time determined by the values of the choke L1 and capacitor bank C1. As switch M1 is switched off, current flows through diode D5 and into capacitor bank C1, which stores the energy of the periodic pulses of current to convert the pulsation dc current into a smooth dc voltage for a load 18. By varying the duty ratio of the switch M1, the pulses of current through choke L1 can shape the choke current into a sinusoidal waveform in phase with the mains ac voltage, thereby maintaining a power factor of 1.

The maximum r.m.s choke current, I_{choke}_{_{—}}ₘₐₓ_{_{—}}_{dc}, may be estimated from
I_{choke}_{_{—}}ₘₐₓ_{_{—}}_{dc}=Pₒ/(ηVᵢₙ_{_{—}}ₘᵢₙ) EQU (1)
where Vₒ is the output voltage (for example, 400V), which for this circuit is the same as the voltage V_{C1} output from the capacitor bank C1, Pₒ is the output power rating, for example 1 kW, Vᵢₙ_{_{—}}ₘᵢₙ is the minimum voltage (typically 90V) of the mains voltage, Vᵢₙ, and η is the dc booster efficiency, generally about 0.95.

In order to maintain the output voltage at the required level, the average duty ratio, D_{dc}, of switch M1 is selected according to equation (2) below.
D_{dc}=(Vₒ−Vᵢₙ)/Vₒ EQU (2)

Thus, the maximum average duty ratio Dₘₐₓ occurs at the lowest mains input voltage; when Vₒ=400V and Vᵢₙ=Vᵢₙ_{_{—}}ₘᵢₙ=90V, D_{dc}_{_{—}}ₘₐₓ=0.775.

The choke rated inductance is determined from the duty ratio, input mains voltage, switch frequency fₛ and desired ripple current Iᵣᵢₚ (resulting from the flow of energy into and out from the capacitor bank C1) as shown in EQU (3), in which the desired ripple current is 20% of I_{choke}_{_{—}}ₘₐₓ_{_{—}}_{dc}.
L_{choke}_{_{—}}_{dc}=D_{dc}Vᵢₙ/(0.2fₛ*I_{choke}_{_{—}}ₘₐₓ_{_{—}}_{dc}) EQU (3)

L_{choke}_{_{—}}_{dc} reaches a maximum, L_{choke}_{_{—}}ₘₐₓ_{_{—}}_{dc}, when Vᵢₙ is 50% of Vₒ. To maintain the desired ripple current, the rated inductance of the choke L1 has to be L_{choke}_{_{—}}ₘₐₓ_{_{—}}_{dc}.

When the switch frequency and choke inductance have been set, the mains ripple current is proportional to the duty ratio and input mains voltage across the choke, when M1 is turned on, as shown in EQU (4).
Iᵣᵢₚ=D_{dc}Vᵢₙ/(fₛ*L_{choke}_{_{—}}ₘₐₓ_{_{—}}_{dc}) EQU (4)

The ripple current also reaches the maximum value when input mains voltage Vᵢₙ, is half of the output voltage Vo.

The minimum r.m.s current of switch M1 is given by equation (5).
I_{rated}_{_{—}}_{M1}={square root over (0.7+0.3D_{dc}_{_{—}}ₘₐₓ)}I_{choke}_{_{—}}ₘₐₓ_{_{—}}_{dc} EQU (5)

There are a number of problems associated with such a PFC circuit For instance, it is clear from the above equations that the booster choke size, the semiconductor switch current, and the mains ripple current are related to the minimum mains voltage. With a low minimum mains voltage of around 90V, the resultant large mains ripple current results in a relatively large EMC filter requirement and high insertion loss to meet EMC criteria, with the resultant large switch current increasing power loss in the switch M1. As the diodes D1 to D4 of the rectifier 12 are in the choke charge and discharge paths, there are power losses on three devices (D1, D4 and D5, or D2, D3 and D5) at any given time, which will generate a relatively large amount of heat requiring dissipation using a heat sink or the like. Furthermore, the average duty ratio at low voltage input is relatively high, and causes relatively large power losses in the switch M1.

With reference to FIG. 2, U.S. Pat. No. 6,411,535 describes a PFC circuit 30 which seeks to increase circuit efficiency by reducing the number of diodes in the choke paths. This PFC circuit 30 is of a double booster variation without an explicit full bridge rectifier. When the mains is in positive half cycle, i.e. the voltage at input I1 is higher than at input I2, a booster consisting of choke L1, switch M1 and diode D3 is operated to convert the ac power to dc power. Using gating signal 1, firstly M1 is turned on to charge the chokes L1 and L2 via diode Dm2. Then M1 is turned off, which results in the chokes L1 and L2 inducing, via diodes D3 and Dm2, a higher voltage and charge in the capacitor C1. When the mains is in negative half cycle, that is the voltage at I1 is lower than at I2, a booster consisting of choke L2, switch M2 and diode D4 is operated to convert the ac power to dc power. Using gating signal 2, M2 is turned on to charge the chokes L1 and L2 via Dm1. When M2 is turned off, the chokes L2 and L1 induce higher voltages and charge the capacitor C1 via diodes D4 and Dm1.

The above equations (1) to (4) are equally applicable to this circuit. In contrast, the r.m.s current ratings of switches M1 and M2 in FIG. 2 are 70% of that given by equation (5), as these switches conduct for only half of the period of the mains cycle. There are only two devices in the conducting paths so the power losses associated with this PFC circuit are lower than those of the PFC circuit of FIG. 1. However, the choke size, inductance and mains ripple current cannot be reduced.

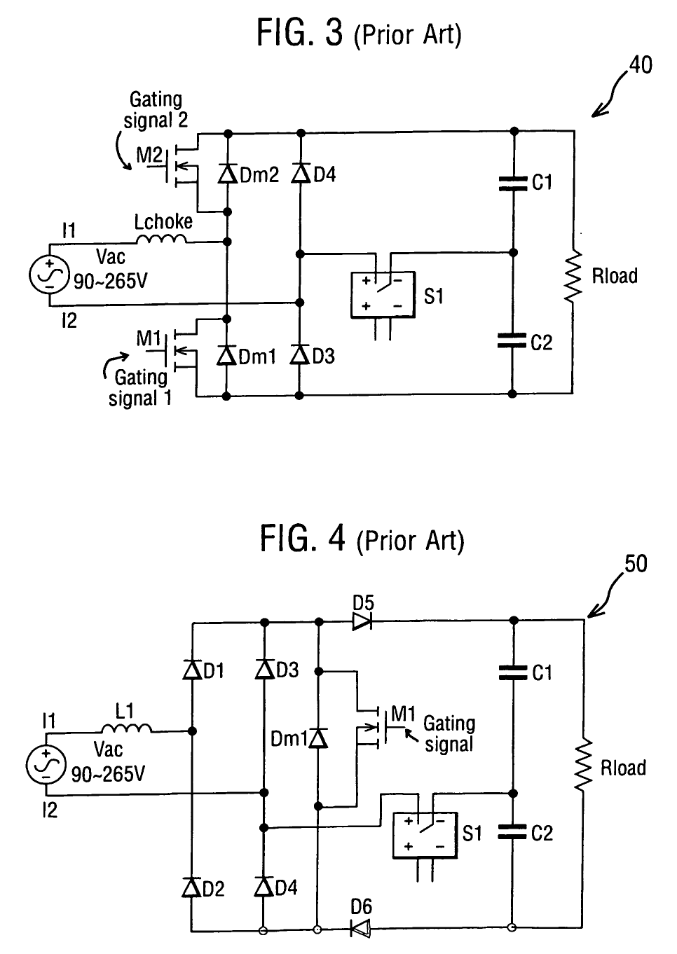

With reference to FIG. 3, the article entitled “Comparative study of power factor correction converters for single phase half-bridge inverters” by Su et al. in the Proceedings of the Power Electronics Specialist Conference 2001 discusses a half bridge booster PFC circuit 40, the topological structure of which is changed depending on the level of the mains input. When the mains input is higher than 150V, the voltage selector switch S1 is open. In the mains positive half cycle, when the voltage at I1 is higher than that at I2, using the gating signal 1 switch M1 is first turned on, to charge the choke Lchoke via diode D3, and subsequently turned off, so that the choke induces a high voltage which charges the serially connected capacitor banks C1 and C2 and supplies power to the load via diodes Dm2 and D3. At the negative half cycle, using the gating signal 2 switch M2 is first turned on, to charge the choke via diode D4, and subsequently turned off, so that the choke induces a high voltage in another direction to charge the capacitor banks C1 and C2 via diodes D4 and Dm1 and supply power to the load. Thus, when M1 or M2 is turned on, there is no power transfer from the mains to the load and the capacitor C1 and C2 supply power to the load.

When the mains voltage is lower than 150V, the voltage selector switch S1 is closed, changing the half bridge booster into a voltage doubler PFC circuit. As a result, only one of the capacitor banks C1 and C2 is charged in each mains half cycle. In the positive half cycle, M1 is turned on to charge the choke via diode D3. However, this will cause capacitor bank C2 to discharge via switch S1, the mains, choke and switch M1. When the M1 is subsequently turned off, the choke generates a high voltage to charge the capacitor bank C1 and supply power to the load. In the negative half cycle, using gating signal 2 switch M2 is first turned on to charge the choke via diode D4. However, this will cause capacitor bank C1 to discharge via switch M2, the choke, the mains and switch S1. When switch M2 is subsequently turned off, the choke L1 produces a high voltage, which charges the capacitor banks C2 via diode Dm1 and supplies power to the load.

Obviously, this voltage doubler circuit has a serious drawback in view of the capacitor banks alternately discharging energy back to the mains. To overcome this problem, this article proposed the PFC circuit 50 shown in FIG. 4, which is a form of single switch voltage doubler booster PFC circuit. In the circuit 50, there are two extra diodes D5, D6 in the dc link to prevent the capacitor discharge problem in the half bridge voltage doubler topology of circuit 40 structure.

When the mains voltage is lower than 150V, switch S1 is closed. In the positive half cycle, switch M1 is turned on to let the mains charge the choke L1 via diodes D1 and D4. As the discharge path of capacitor C2 (via switch S1, the mains, choke L1 and switch M1) is blocked by diode D6, the capacitor bank C2 can only discharge to the load. When switch M1 is turned off, the induced high voltage on choke L1 charges the capacitor bank C1 via D1, D5, and S1 and supplies power to the load. At the negative half cycle, switch M1 is first turned on to charge the choke L1 via diodes D3 and D2. As the discharge path of capacitor bank C1 (via M1, choke L1, the mains and S1) is blocked by diode D5, C1 discharges its stored energy to the load. When M1 is subsequently turned off, the induced high voltage on the choke L1 charges the capacitor bank C2 via S1, D6 and D2 and supplies power to the load.

When the mains input is higher than 150V, the voltage selector switch S1 is open. As a result, the circuit operates in a similar manner to the dc booster circuit 10 of FIG. 1, with the exception that there is one more diode in the negative dc rail, which increases the voltage drop and power loss of the circuit.

It is an object of at least the preferred embodiment of the present invention to solve these and other problems.

In a first aspect, the present invention provides a power factor correction circuit, comprising first and second ac inputs for receiving an ac voltage; rectifying means connected to at least one of the ac inputs; energy storage means connected in parallel across the rectifying means; inductor means connected between one of the ac inputs and the rectifying means; and bi-directional switch means connected to the rectifying means and having means for receiving control signals for controlling the switching thereof so as to control the charging and discharging of the inductor means through the rectifying means.

Preferably, the energy storage means comprises first capacitive means connected at one end thereof to the rectifying means and second capacitive means connected at one end thereof to the other end of the first capacitive means and at the other end thereof to the rectifying means, said other end of the first capacitive means being selectively connectable or connected to one of the ac inputs.

The circuit preferably comprises a voltage selector switch connected between said other end of the first capacitive means and the second ac input. In one arrangement the voltage selector switch is connected to the rectifying means. Preferably, the voltage selector switch comprises means for receiving a signal indicative of the magnitude of the ac voltage to control the switching of the voltage selector switch.

Preferably, the inductor means comprises a first inductor connected between the first ac input and a first rectifier input, and, optionally, a second inductor connected between the second ac input and a second rectifier input.

In one arrangement, the bi-directional switch comprises a first field effect transistor or Insulated Gate Bipolar Transistor and a second field effect transistor or Insulated Gate Bipolar Transistor, the gates of the first and second transistors being arranged to receive the control signals, the source/emitter of the first transistor being connected to the source/emitter of the second transistor, the drain/collector of the first transistor being connected to the first ac input, and the drain/collector of the second transistor being connected to the second ac input.

In an alternative arrangement, the bi-directional switch comprises a first field effect transistor or Insulated Gate Bipolar Transistor and a second field effect transistor or Insulated Gate Bipolar Transistor, the gates of the first and second transistors being arranged to receive the control signals, the drain/collector of the first transistor being connected to the drain/collector of the second transistor, the source/emitter of the first transistor being connected to the first ac input, and the source/emitter of the second transistor being connected to the second ac input.

Where the bi-directional switch comprises bipolar transistors, the bi-directional switch preferably also comprises a first diode connected at one end thereof to the collector of the first bipolar transistor and at the other-end-thereof-to the emitter of the first bipolar transistor, and a second diode connected at one end thereof to the collector of the second bipolar transistor and at the other end thereof to the emitter of the second bipolar transistor.

In a second aspect, the present invention provides a power factor correction circuit, comprising first and second ac inputs for receiving an ac voltage; rectifying means having first and second rectifier inputs each connected to a respective ac input, and first and second rectifier outputs for outputting a dc voltage; energy storage means connected between the rectifier outputs; inductor means connected between one of the ac inputs and a corresponding one of the rectifier inputs; and bi-directional switch means connected to the first and second rectifier inputs and having means for receiving control signals for controlling the switching thereof so as to control the charging and discharging of the inductor means through the rectifying means.

In a third aspect, the present invention provides a method of providing direct current power to a load from an alternating current power source, the method comprising the steps of providing a circuit as aforementioned, connecting the ac inputs to the power source, and controlling the switching of the bi-directional switch means according to the magnitude of the ac voltage output from the power source, for example, according to the r.m.s. current flowing through the inductor means.

Preferred features of the present invention will now be described, by way of example only, with reference to the accompanying drawings, in which:

FIG. 1 illustrates a known dc booster PFC circuit;

FIG. 2 illustrates a known twin ac booster PFC circuit;

FIG. 3 illustrates a known half bridge ac booster PFC circuit;

FIG. 4 illustrates a known full bridge, single switch ac booster PFC circuit;

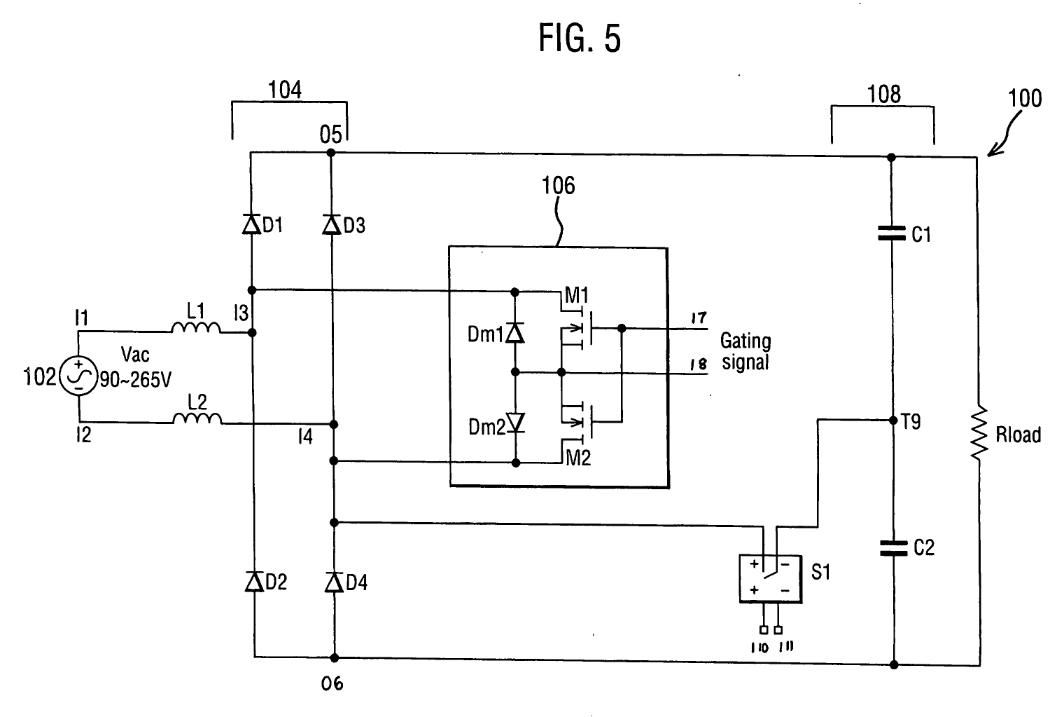

FIG. 5 illustrates an embodiment of a PFC circuit;

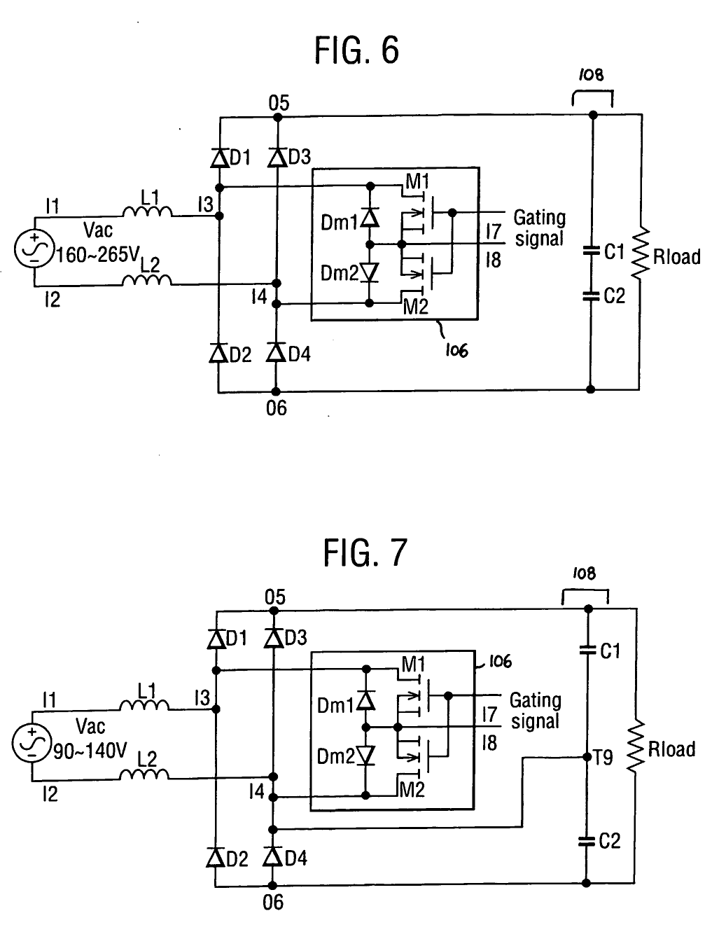

FIG. 6 illustrates the topology of the circuit of FIG. 5 with switch S1 open;

FIG. 7 illustrates the topology of the circuit of FIG. 5 with switch S1 closed;

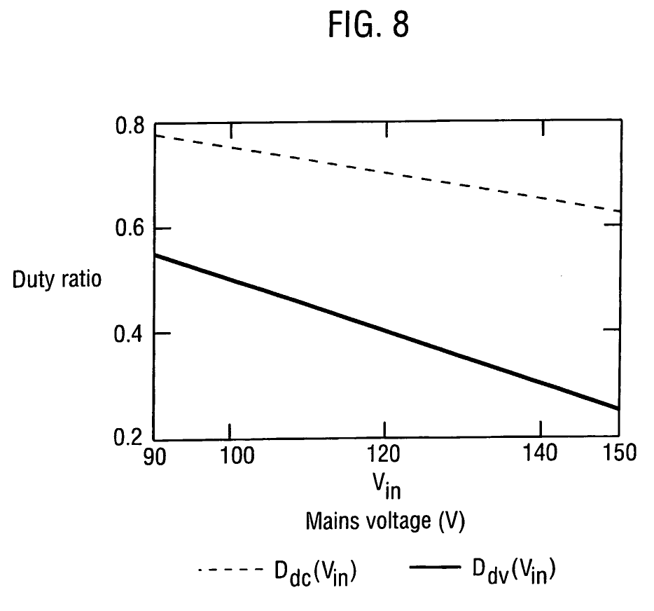

FIG. 8 is a graph illustrating the variation of average duty ratio with input ac voltage for the PFC circuits of FIGS. 1 and 5;

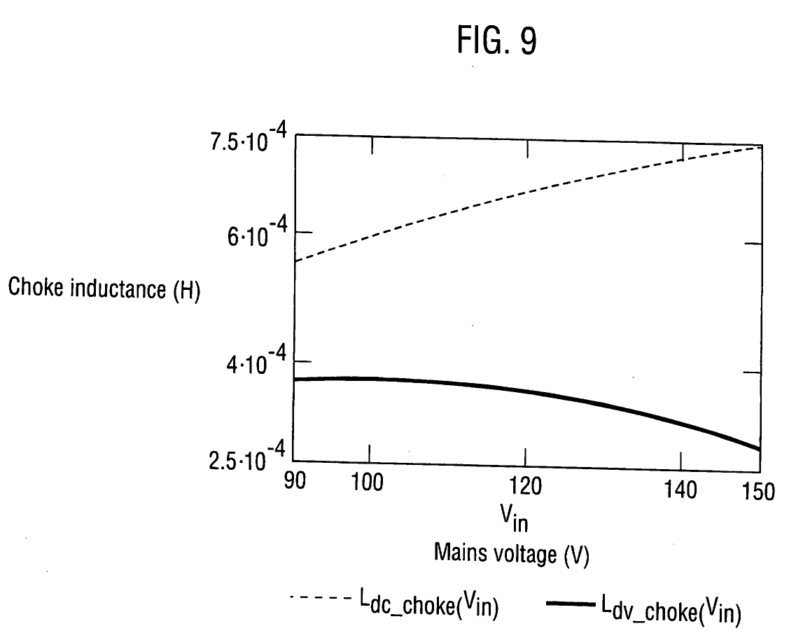

FIG. 9 is a graph illustrating the variation of choke inductance with input ac voltage for the PFC circuits of FIGS. 1 and 5;

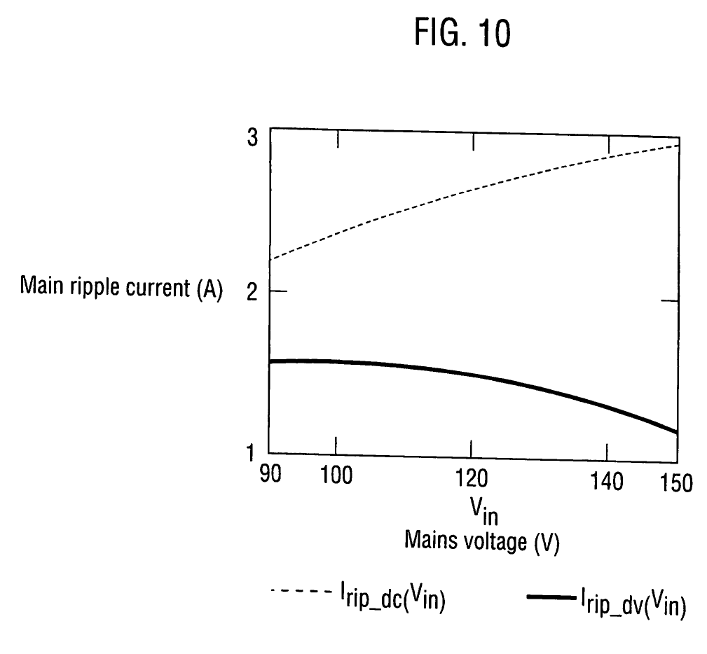

FIG. 10 is a graph illustrating the variation of mains ripple current with input ac voltage for the PFC circuits of FIGS. 1 and 5;

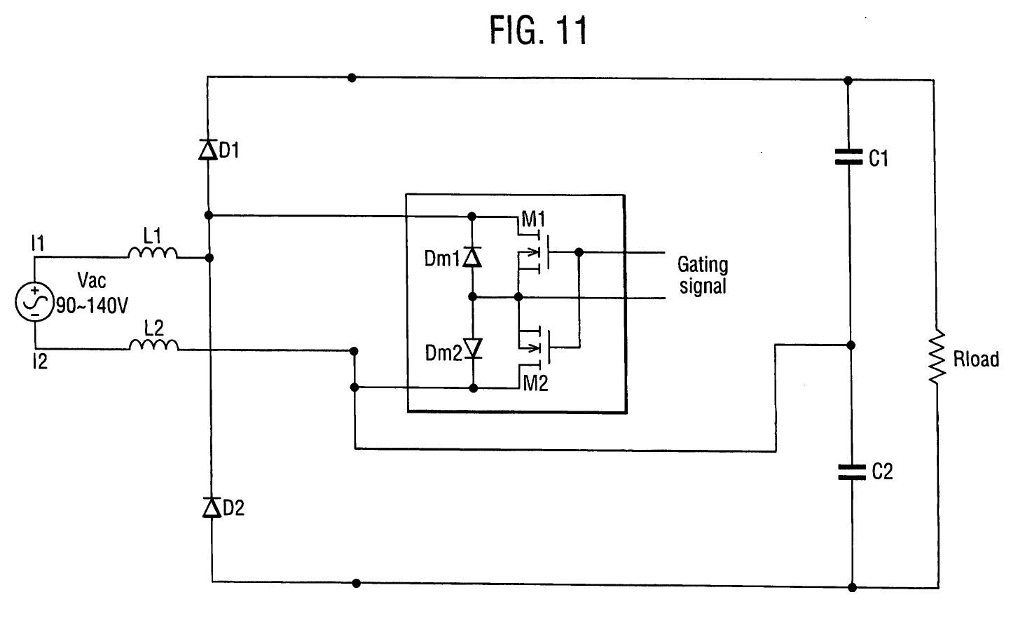

FIG. 11 illustrates an alternative topology of the circuit of FIG. 5 with switch S1 closed; and

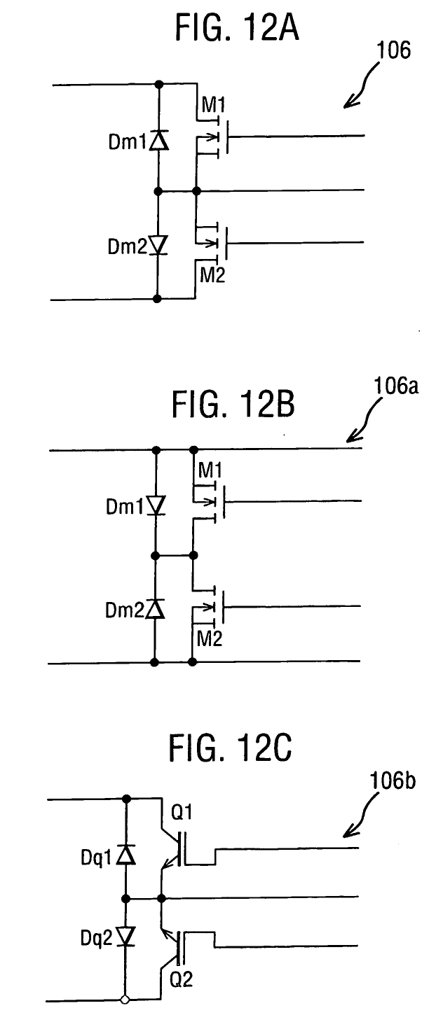

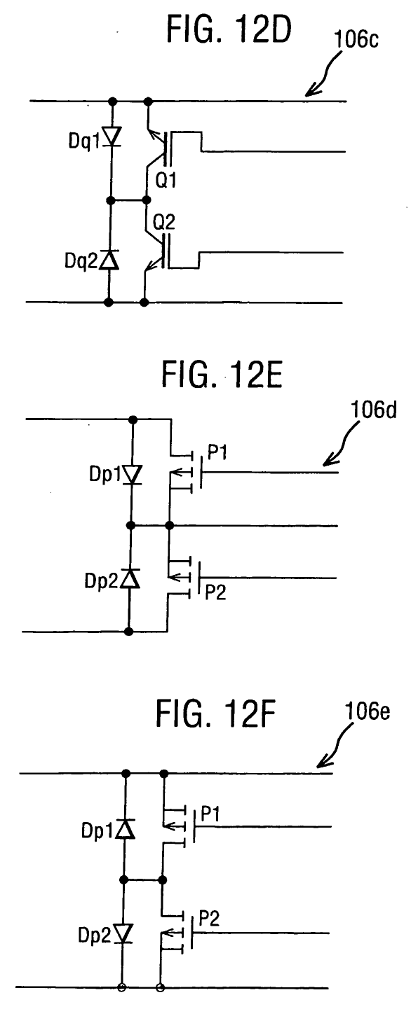

FIGS. 12(a) to 12(f) illustrate various alternative configurations of the bi-directional switch of the circuit of FIG. 5.

With reference to FIG. 5, a PFC circuit 100 comprises first and second ac inputs I1, I2 for receiving an ac voltage from ac source 102. An inductor, or choke, L1 is connected at one end thereof to ac input I1 and at the other end thereof to a first input I3 of rectifier 104. Optionally, as indicated in FIG. 5, a second inductor, or choke, L2 may be connected at one end thereof to ac input 12 and to a second input I4 of rectifier 104. The rectifier 104 consists of a first diode D1 connected between the first rectifier input I3 and a first rectifier output O5, a second diode D2 connected between second rectifier output O6 and the first rectifier input I3, a third diode D3 connected between the second rectifier input I4 and the first rectifier output O5, and a fourth diode D4 connected between the second rectifier output O6 and the second rectifier input I4.

The PFC circuit also comprises a bi-directional switch 106 connected to the first and second rectifier inputs I3, I4. In the embodiment shown in FIG. 5, the bi-directional switch comprises two back-to back switches M1, preferably in the form of a first field effect transistor, or MOSFET, M1 and a second field effect transistor, or MOSFET, M2. The gates of MOSFETS M1, M2 are arranged to receive a gating control signal applied between switch inputs I7, I8. As discussed below, in this preferred embodiment the gating signal controls the switching of the bi-directional switch 106 according to the magnitude of the mains ac voltage, an indication of which may be provided by the choke current I_{choke}. The source of MOSFET M1 is connected to the source of MOSFET M2. The drain of MOSFET M1 is connected to the first rectifier input I3, and thus to the first ac input I1, and the drain of MOSFET M2 is connected to the second rectifier input I4, and thus to second ac input I2. In the illustrated embodiment, the bi-directional switch 106 includes a first diode Dm1 connected between the source and drain of MOSFET M1, and a second diode Dm2 connected between the source and drain of MOSFET M2. It is to be noted that the diodes Dm1 and Dm2 are the body diodes of transistors M1 and M2, and not physically separate diodes. However, such diodes are required if the bi-directional switch is implemented using other components, such as Insulated Gate Bipolar Transistors (IGBTs)

The circuit 100 also comprises an energy store 108 connected between the first and second rectifier outputs O5, O6. In the illustrated embodiment, the energy store 108 consists of a first capacitor, or capacitor bank, C1 and a second capacitor, or capacitor bank, C2, the first and second capacitors C1, C2 being serially connected via terminal T9.

Terminal T9 is connected to the second rectifier input I4 via a switch S1. Preferably, switch S1 is a voltage selector switch having first and second switch inputs I10, I11 for receiving therebetween a signal indicative of the magnitude of the mains ac voltage received by inputs I1, I2, the magnitude of the signal input to inputs I10, I11 controlling the opening and closing of the path between terminal T9 and rectifier input I4. Alternatively, the switch S1 may be a manually operable switch, or any other suitable form of switch.

The PFC circuit topology and the operational principles of the PFC circuit 100 change with the opening and closing of the switch S1. At a higher mains input (in the range, say, from 180V to 265V), switch S1 is opened, and the resulting equivalent circuit, as shown in FIG. 6, is in the form of a full bridge ac booster PFC circuit. At lower mains input (in the range, say, from 90V to 150V), switch S1 is closed and the resulting equivalent circuit, as shown in FIG. 7, is in the form of a half bridge voltage doubler PFC circuit. The modes of operation of these two circuits are discussed separately below.

High Voltage Operation Mode

With reference to FIG. 6, during positive half cycle of the mains ac voltage, where the voltage at I1 is higher than that at I2, a suitable gating signal is applied between inputs I7, I8 to “switch on” the bi-directional switch 106, that is, by rendering MOSFET M1 conductive, to connect the choke L1 (and optional choke L2) to the mains via diode Dm2. The choke current I_{choke} linearly increases in proportion to the magnitude of the mains voltage. When I_{choke}, reaches a predetermined level, the gate signal is changed to “switch off” the bi-directional switch, by rendering MOSFET M1 non-conductive. The large voltage induced across the choke L1, by the subsequent rapid decay of the choke current, is superimposed on the mains voltage, which both charges the energy store 108, in this case consisting of the serially connected capacitors C1 and C2, and supplies power to the load, indicates by Rload in FIGS. 5 to 7, via diodes D1 and D4.

At negative half cycle of the mains input voltage, where the voltage at I2 is higher than that at I1, a suitable gating signal is applied between inputs I7, I8 to “switch on” the bi-directional switch 106, that is, by rendering MOSFET M2 conductive, to connect the choke L1 (and optional choke L2) to the mains via diode Dm1. Again, the choke current I_{choke} linearly increases in proportion to the magnitude of the mains voltage. When I_{choke}, reaches a predetermined level, the gate signal is changed to “switch off” the bi-directional switch, by rendering MOSFET M2 non-conductive. The large voltage induced across the choke L1, by the subsequent rapid decay of the choke current, is superimposed on the mains voltage, which both charges the energy store 108 and supplies power to the load via diodes D3 and D2.

For the circuit illustrated in FIG. 6, the maximum choke current, I_{choke}_{_{—}}ₘₐₓ_{_{—}}_{ac}, may be estimated from
I_{choke}_{_{—}}ₘₐₓ_{_{—}}_{ac}=Pₒ/(ηVᵢₙ_{_{—}}ₘᵢₙ₁) EQU (6)
where Pₒ and η have the same meaning as in equation (1), and Vᵢₙ_{_{—}}ₘᵢₙ₁ is the minimum voltage (typically 180V) of the mains voltage, Vᵢₙ, in this high voltage operational mode.

The average duty cycle D_{ac}, is selected according to the equation (7) below.
D_{ac}=(Vₒ−Vᵢₙ)/Vₒ EQU (7)
where Vₒ is the output voltage, which is also the same as the voltage V_{C1+C2} output from the serially connected capacitors C1 and C2. At the lowest mains input voltage, when Vᵢₙ=Vᵢₙ_{_{—}}ₘᵢₙ₁=180V, and when Vₒ=400V, D_{ac}_{_{—}}ₘₐₓ=0.55.

The choke rated inductance L_{choke}_{_{—}}_{ac} is determined from the duty ratio, input mains voltage, switch frequency fₛ and desired ripple current Iᵣᵢₚ (resulting from the flow of energy into and out from the serially connected capacitors C1 and C2) as shown in EQU (8), in which the desired ripple current is 20% of I_{choke}_{_{—}}ₘₐₓ_{_{—}}_{ac}.
L_{choke}_{_{—}}_{ac}=D_{ac}Vᵢₙ/(0.2fₛ*I_{choke}_{_{—}}ₘₐₓ_{_{—}}_{ac}) EQU (8)

L_{choke}_{_{—}}_{ac} reaches a maximum, L_{choke}_{_{—}}ₘₐₓ_{_{—}}_{ac}, when Vᵢₙ is 50% of Vₒ. To maintain the desired ripple current, the rated inductance of the choke L1 (or, optionally L1+L2) has to be L_{choke}_{_{—}}ₘₐₓ_{_{—}}_{ac}.

When the switch frequency and choke inductance have been set, the mains ripple current is proportional to the duty ratio and input mains voltage across the choke L1, when the bi-directional switch 106 is turned on, as shown in EQU (9).
Iᵣᵢₚ=D_{ac}Vᵢₙ/(fₛ*L_{choke}_{_{—}}ₘₐₓ_{_{—}}_{ac}) EQU (9)

The ripple current also reaches the maximum value when input mains voltage Vᵢₙ is half of the output voltage Vo.

The minimum r.m.s current of MOSFETs M1 and M2 is given by equation (10).
I_{rated}_{_{—}}_{M}={square root over (0.7+0.3D_{ac}_{_{—max}})}I_{choke}_{_{—}}ₘₐₓ_{_{—}}_{ac}/\sqrt{2} EQU (10)

Returning to FIG. 6, during both positive and negative half cycles there is only ever one diode (Dm1 or Dm2) in the charge path of the choke L1 (and optional choke L2), and two diodes (D1 and D4, or D3 and D2) in the choke discharge path. This is the same as in the prior art circuits described in with reference to FIGS. 2 and 3. In contrast, in the prior art circuit described with reference to FIG. 1 there are always two diodes in the choke charges path, and three diodes in the choke discharge path. Furthermore, in the prior art circuit described with reference to FIG. 4, there are always two diodes in the choke charge path and, in high voltage operational mode, four diodes in the choke discharge path. Thus, in high voltage operational mode, the PFC circuit 100 has smaller power losses associated therewith than the prior art circuits illustrated in FIGS. 1 and 4.

Low Voltage Operation Mode

With reference to FIG. 7, during positive half cycle of the mains ac voltage, where the voltage at I1 is higher than that at I2, a suitable gating signal is applied between inputs I7, I8 to “switch on” the bi-directional switch 106, that is, by rendering MOSFET M1 conductive, to connect the choke L1 (and optional choke L2) to the mains via diode Dm2. The choke current I_{choke} linearly increases in proportion to the size of the mains voltage. When I_{choke}, reaches a predetermined level, the gate signal is changed to “switch off” the bi-directional switch, by rendering MOSFET M1 non-conductive. The large voltage induced across the choke L1, by the subsequent rapid decay of the choke current, is superimposed on the mains voltage, which both charges the capacitor bank C1, and supplies power to the load through capacitor bank C2. The conduction path is from I1 to I3 via L1, then to O5 via diode D1, then to T9 through both C1 and Rload (via C2), then to I4 through the closed switch S1, and finally back to I1 via I2 (and optionally L2) and the mains.

During negative half cycle of the mains ac voltage, where the voltage at I2 is higher than that at I1, a suitable gating signal is applied between inputs I7, I8 to “switch on” the bi-directional switch 106, that is, by rendering MOSFET M2 conductive, to connect the choke L1 (and optional choke L2) to the mains via diode Dm1. The choke current I_{choke} linearly increases in proportion to the magnitude of the mains voltage. When I_{choke}, reaches a predetermined level, the gate signal is changed to “switch off” the bi-directional switch, by rendering MOSFET M2 non-conductive. The large voltage induced across the choke L1, by the subsequent rapid decay of the choke current, is superimposed on the mains voltage, which both charges the capacitor bank C2, and supplies power to the load through capacitor bank C1. The conduction path is from I2 to I4 (optionally via L2), then to T9 through the closed switch S1, then to O6 through both C2 and Rload (via C1), then to I3 via diode D2, and finally back to I2 via I1, L1 and the mains.

For the circuit illustrated in FIG. 7, the maximum choke current, I_{choke}_{_{—}}ₘₐₓ_{_{—}}_{dv}, may be estimated from
I_{choke}_{_{—}}ₘₐₓ_{_{—}}_{dv}=Pₒ/(ηVᵢₙ_{_{—}}ₘᵢₙ₂) EQU (11)
where Pₒ and η have the same meaning as in equation (1), and Vᵢₙ_{_{—}}ₘᵢₙ₂ is the minimum voltage (typically 90V) of the mains voltage, Vᵢₙ, in this low voltage operational mode.

The average duty cycle D_{dv}, is selected according to the equation (12) below.
D_{dv}=(V_{C}−Vᵢₙ)/V_{C} EQU (12)
as Vₒ, the output voltage, in this circuit is twice the output voltage V_{C} from each of the capacitors C1 and C2. At the lowest mains input voltage, when Vᵢₙ=Vᵢₙ_{_{—}}ₘᵢₙ₂=90V, and when V_{c}=200V, D_{dv}_{_{—}}ₘₐₓ=0.55.

The choke rated inductance L_{choke}_{_{—}}_{dv} is determined from the duty ratio, input mains voltage, switch frequency fₛ and desired ripple current Iᵣᵢₚ (resulting from the flow of energy into and out from the capacitors C1 and C2) as shown in EQU (13), in which the desired ripple current is 20% of I_{choke}_{_{—}}ₘₐₓ_{_{—}}_{dv}.
L_{choke}_{_{—}}_{dv}=D_{dv}Vᵢₙ/(0.2fₛ*I_{choke}_{_{—}}ₘₐₓ_{_{—}}_{dv}) EQU (13)

L_{choke}_{_{—}}_{dv} reaches a maximum, L_{choke}_{_{—}}ₘₐₓ_{_{—}}_{dv}, when Vᵢₙ is 50% of V_{C}. To maintain the desired ripple current, the rated inductance of the choke L1 (or, optionally L1+L2) has to be L_{choke}_{_{—}}ₘₐₓ_{_{—}}_{dv}.

When the switch frequency and choke inductance have been set, the mains ripple current is proportional to the duty ratio and input mains voltage across the choke, when the bi-directional switch 106 is turned on, as shown in EQU (14).
Iᵣᵢₚ=D_{dv}Vᵢₙ/(fₛ*L_{choke}_{_{—}}ₘₐₓ_{_{—}}_{dv}) EQU (14)

The ripple current also reaches the maximum value when input mains voltage Vᵢₙ is half of V_{C}.

The minimum r.m.s current of MOSFETs M1 and M2 is given by equation (15).
I_{rated}_{_{—}}_{M}=\sqrt{0.7+0.3Ddv_{—max}}I_{choke}_{_{—}}ₘₐₓ_{_{—}}_{dv}/\sqrt{2} EQU (15)

Thus, in comparison to the prior art circuits described with reference to FIG. 1 and 2 (when operated in the low voltage range), the PFC circuit 100, when operating in the lower voltage range, has a number of advantages. First, the PFC circuit 100 has a smaller average duty ratio (see FIG. 8) over a range of values of Vᵢₙ, which eases the dynamic response requirement on the control system. Secondly, the PFC circuit 100 enables the choke inductances to be reduced (see FIG. 9), leading to a smaller choke size and lower costs. Additionally, the PFC circuit 100 has a smaller mains ripple current (see FIG. 10) over a range of values of Vᵢₙ, which reduces the high frequency harmonic current, conductive emission pollution and MOSFET current rating to nearly 50%. These lead to a smaller EMC filter size, lower insertion losses and attenuation, and lower MOSFET conduction and switch losses due to the smaller duty ratio and ripple current.

Furthermore, during both positive and negative half cycles, there is only ever one diode (Dm1 or Dm2) in the charge path of the choke L1 (and optional choke L2) and one diode (D1 or D2) in the choke discharge path. There are also no problems associated with unwanted capacitor discharge, unlike the prior art circuit described with reference to FIG. 3. When the prior art circuit described with reference to FIG. 4 is operated in voltage doubler mode, there are two diodes in both the choke charge and discharge paths, and thus in low voltage operational mode, again the PFC circuit 100 has smaller power losses associated therewith than the prior art circuits illustrated in FIGS. 1 and 4. As a result, the system thermal management requirement is less demanding, and so smaller heat sinks or fans are required.

These advantages enable the PFC circuit 100 to offer a sustainable wider output voltage range than the PFC circuits illustrated in FIGS. 1, 2 and 3, and to boost a higher output power with the same semiconductor switch device rating as these three known PFC circuits, especially in the lower voltage input range. The PFC circuit 100 can maintain a uniform output power rating in the wide single phase universal voltage range without incurring additional costs. In turn, these can offer the opportunity to build larger power PFC equipment using a smaller rating, economical device. The PFC 100 circuit could be switched at lower frequency; about 30% lower, at a lower mains input without deteriorating the power factor, harmonics and emission performance. This can further improve the overall system efficiency and running cost.

Furthermore, the prior art circuit shown in FIG. 1 has notorious thermal runaway problems when operated in the lower mains input voltage because of the relatively large input current, larger conducting duty ratio and higher boost voltage ratio. These problems are greatly relieved or overcome in the PFC circuit 100.

The electrolytic capacitor in dc link is the weakest part in a system life span. Using two lower voltage, double capacitance capacitors to replace a single higher voltage capacitor will extend the system life time. The high frequency PFC choke is the most expansive, bulky and important passive part in all PFC circuits, and its life time is greatly effected by the mains ripple current, as a larger ripple current causes more copper and iron losses and increases temperature rise. The PFC 100 reduces the mains ripple nearly 50% and thus reduces power losses on the choke and extends its useful life time. For the prior art circuits illustrated in FIGS. 1, 2 and 3, the most worst operation condition is at the lowest mains input voltage, in which high voltage, current and thermal stresses on a single switch and diode device causes greater reliability and performance concerns. These concerns are greatly relieved by the change of circuit topology in the PFC circuit 100 and as result reliability and performance are improved.

It is to be understood that the foregoing represents one embodiment of the invention, others of which will no doubt occur to the skilled addressee without departing from the true scope of the invention as defined by the claims appended hereto.

For example, with reference to the circuit topology described above with reference to FIG. 7, the diodes D3 and D4 form no part of various charge and discharge paths of the circuit. Therefore, as illustrated in FIG. 11 it is possible for these diodes to be omitted altogether from the PFC circuit when the mains ac voltage is in the lower voltage range.

In the circuit illustrated in FIGS. 5 to 7, the bi-directional switch 106 is embodied by an N MOSFET common source bi-directional switch, as also illustrated in FIG. 12(a). However, the bi-directional switch 106 could be replaced by any of the bi-directional switches 106a to 106e illustrated in FIGS. 12(b) to 12(f). FIG. 12(b) illustrates an N MOSFET common drain bi-directional switch 106a, FIG. 12(c) illustrates an IGBT common emitter bi-directional switch 106b, FIG. 12(d) illustrates an IGBT common collector bi-directional switch 106c, FIG. 12(e) illustrates a P MOSFET common source bi-directional switch 106d, and FIG. 12(f) illustrates a P MOSFET common drain bi-directional switch 106e. The operation of these switches is well known to the skilled addressee, and will not be explained further here. Other suitable bi-directional switches, such as a full diode bridge type bi-directional switch, will be readily apparent to the skilled addressee.

In summary, a power factor correction circuit comprises first and second ac inputs I1, I2 for receiving an ac voltage. A rectifier 104 has first and second rectifier inputs I3, I4 each connected to a respective ac input I1, I2, and first and second rectifier outputs O5, O6 for outputting a dc voltage. Two capacitor banks C1, C2 are connected in series between the rectifier outputs O5, O6. A choke L1 is connected between ac input I1 and rectifier input I3. A bi-directional switch 106 is connected to the rectifier inputs I3, I4 and receives a control signal for controlling the switching of the bi-directional switch 106 so as to control the charging and discharging of the choke L1 through the rectifier 104. A mid-point between the two capacitor banks C1, C2 is selectively connectable to the ac input I2 according to the magnitude of the ac voltage.

1. A power factor correction circuit, comprising:
first and second ac inputs for receiving an ac voltage;
rectifying means connected to at least one of the ac inputs;
energy storage means connected in parallel across the rectifying means;
inductor means connected between one of the ac inputs and the rectifying means; and
bi-directional switch means connected to the rectifying means and having means for receiving control signals for controlling the switching thereof so as to control the charging and discharging of the inductor means through the rectifying means,
wherein the energy storage means comprises first capacitive means connected at one end thereof to the rectifying means and second capacitive means connected at one end thereof to the other end of the first capacitive means and at the other end thereof to the rectifying means, the other end of the first capacitive means being connected or selectively connectable to one of the ac inputs.

2. The circuit according to claim 1 wherein the other end of the first capacitive means is selectively connectable to the one of the ac inputs.

3. The circuit according to claim 1 comprising a voltage selector switch connected between the other end of the first capacitive means and the second ac input.

4. The circuit according to claim 3 wherein the voltage selector switch is connected to the rectifying means.

5. The circuit according to claim 3 wherein the voltage selector switch comprises means for receiving a signal indicative of the magnitude of the ac voltage to control the switching of the voltage selector switch.

6. The circuit according to claim 1 wherein the inductor means comprises a first inductor connected between the first ac input and a first rectifier input, and optionally a second inductor connected between the second ac input and a second rectifier input.

7. The circuit according to claim 1 wherein the bi-directional switch comprises a first field effect transistor or Insulated Gate Bipolar Transistor and a second field effect transistor or Insulated Gate Bipolar Transistor, the gates of the first and second transistors being arranged to receive the control signals, the source of the first transistor being connected to the source of the second transistor, the drain of the first transistor being connected to the first ac input, and the drain of the second transistor being connected to the second ac input.

8. The circuit according to claims 1 wherein the bi-directional switch comprises a first field effect transistor or Insulated Gate Bipolar Transistor and a second field effect transistor or Insulated Gate Bipolar Transistor, the gates of the first and second transistors being arranged to receive the control signals, the drain of the first transistor being connected to the drain of the second transistor, the source of the first transistor being connected to the first ac input, and the source of the second transistor being connected to the second ac input.

9. The circuit according to claim 7 wherein the bi-directional switch comprises a first diode connected at one end thereof to the collector of the first bipolar transistor and at the other end thereof to the emitter of the first bipolar transistor, and a second diode connected at one end thereof to the collector of the second bipolar transistor and at the other end thereof to the emitter of the second bipolar transistor.

10. A power factor correction circuit comprising:
first and second ac inputs for receiving an ac voltage;
rectifying means having first and second rectifier inputs each connected to a respective ac input, and first and second rectifier outputs for outputting a dc voltage;
energy storage means connected between the rectifier outputs;
inductor means connected between one of the ac inputs and a corresponding one of the rectifier inputs; and
bi-directional switch-means-connected to the first and second rectifier inputs and having means for receiving control signals for controlling the switching thereof so as to control the charging and discharging of the inductor means through the rectifying means.

11. The circuit according to claim 10 wherein the control signals for controlling the switching of the bi-directional switch means are indicative of the magnitude of the ac voltage.

12. The circuit according to claim 11 wherein the control signals for controlling the switching of the bi-directional switch means are indicative of the current flowing through the inductor means.

13. A method of providing direct current power to a load from an alternating current power source, the method comprising the steps of:
providing a circuit comprising first and second ac inputs, a rectifying means connected to at least one of the ac inputs, an energy storage means connected across the rectifying means, an inductor means connected between one of the ac inputs and the rectifying means, and a bi-directional switch means connected to the rectifying means and having means for receiving control signals,
connecting the ac inputs to the power source; and
controlling the switching of the bi-directional switch means according to the magnitude of the ac voltage output from the power source.

14. The circuit according to claim 1 wherein the control signals for controlling the switching of the bi-directional switch means are indicative of the magnitude of the ac voltage.

15. The circuit according to claim 14 wherein the control signals for controlling the switching of the bi-directional switch means are indicative of the current flowing through the inductor means.
